(19) United States
(12) Patent Application Publication
(10) Pub. No.: US 2008/0235339 A1
(43) Pub. Date: Sep. 25, 2008

(54) SUBJECT MATTER RESOURCE WEBSITE

(75) Inventors: Craig Lurey, El Dorado Hills, CA (US); Ryan Rouland, Aliso Viejo, CA (US); Darren Guccione, Chicago, IL (US)

Correspondence Address: WELSH & KATZ, LTD, 120 S RIVERSIDE PLAZA, 22ND FLOOR, CHICAGO, IL, 60606, US

(73) Assignee: Snipitron, LLC, Chicago, IL (US)

(21) Appl. No.: 12/036,042

(22) Filed: Feb. 22, 2008

Related U.S. Application Data
(60) Provisional application No. 60/902,799, filed on Feb. 22, 2007.

(51) Int. Cl. G06F 15/16; G06F 17/00; G06F 7/06; G06F 17/30

(52) U.S. Cl. 709/206; 715/230; 707/5; 707/9; 707/E17.014

(57) ABSTRACT

A method and apparatus for providing searchable data. The method includes the steps of detecting a content capture request from a user and analyzing a screen being viewed by the user to capture a content and format of any information elements displayed on the screen. The method further includes the steps of prompting the user for descriptive information about the viewed content and saving the captured content and format and descriptive information as a subject matter resource within a subject matter resource file located at a predetermined website or physical location on the user's computer.

### FIELD OF THE INVENTION

The field of the invention relates to the Internet and more particularly to information on websites available through the Internet.

### BACKGROUND

This application depends from U.S. Provisional Patent Application No. 60/902,799 filed on Feb. 22, 2007.

Large numbers of users around the world make use of the Internet to communicate with co-workers and friends. In addition to simple messaging, a new category of web sites dedicated towards the sharing of content and media has emerged, thus enhancing the experience for users. Examples of these web sites include Flickr.com (for sharing of photos), YouTube.com (for sharing of video), and MySpace (for sharing of music and text messaging).

In addition to messaging, numerous websites containing information content have been provided along with search engines for finding that content. However, as website developers have become more accustomed to methods of searching and to search engine optimization (SEO), the overall usefulness of search engines like Google have been diminished, because the search results often contain many mislabeled or incorrectly ranked websites. As a result, it has become more difficult for users to find a desired content.

The process in which users currently write and publish content online is through a web browser and web-based HTML forms. Users typically type their content into a form, and click a “submit” button to save the content to a database. The web browser is the primary method of manually entering content. This may work well for some users that use the Internet for chatting with friends, but a better method of publishing content for professionals, student, educators, and businesspersons is needed to enhance productivity and speed up the process.

### SUMMARY

A method and apparatus for providing searchable data. The method includes the steps of detecting a content capture request from a user and analyzing a screen being viewed by the user to capture a content and format of any information elements displayed on the screen. The method further includes the steps of prompting the user for descriptive information about the viewed content and saving the captured content and format and descriptive information as a subject matter resource within a subject matter resource file located at a predetermined website or physical location on the user's computer.

The inventive concept involves two parts: one part is a method to assist users in the creation of content. The other part is a website search engine that is based on user-generated content.

The unique method of building content developed under illustrated embodiments of the invention allows users to quickly transmit content from their desktop computer. The steps to the process are explained as follows: a. User registers for an account on the website; b. User downloads a small executable application to their computer; c. The claimed application is installed to their computer on the local hard drive; d. When the user wishes to transmit content, they simply hit a “hot key” on their keyboard; e. the application analyzes what the user is currently viewing (i.e. a web browser, productivity application, or any other application installed on their computer); f. the application prompts the user for some information about what they are doing (add notes) and g. the application transmits whatever file the user was currently viewing or working on, as well as a screenshot of the active window, and a thumbnail screenshot of the active window to the claimed servers in the background. If the user was viewing a web site, the HTML page source is also transmitted to the servers. In addition, when the user is finished capturing content on a chosen subject, they may hit another hot key on their keyboard to view the published content on the claimed website.

As an example, let's say that a user named Joe is a marketing manager at an electronics company. Joe may use the claimed website to research his competitors online. Whenever he comes across a competitive product, he hits the Hot Key on his keyboard, types a few notes, and the content is instantly saved to his online account for viewing later. When he is done with his research, he can email a link to his research to his co-workers. From there the co-workers may optionally add comments or content of their own to Joe's project. The project will contain websites, documents, and other content related to Joe's research on competitive products. Additionally, the web HTML content is cached on the servers, so the content is preserved just as Joe viewed it (i.e. web pages never go stale because of later changes to the website).

The search engine is directed to the user generated content described above. Research projects saved on the website may be set as “Public” or “Private” by the user. As the usage of the claimed website continues, the amount of public research expands to include a broad range of subject matter that is searchable by other end-users looking for research on a particular topic. In essense, the claimed website slowly builds up a catalog of research performed on topics that apply to the general public. As a result, it may become more relevant to use the website to search for information on a topic rather than traditional search engines like Google, Ask.com, and Yahoo! Since the website does not actively spider content on the Internet without user's request, the information stored on the servers is more focused and relevant on a topic of choice.

### BRIEF DESCRIPTION OF THE DRAWINGS

FIG. 1 is a block diagram of a communication system in accordance with an illustrated embodiment of the invention;

FIG. 2 is a block diagram of a first portion of a software system that may be used by the communication system of FIG. 1;

FIG. 3 is a block diagram of a second portion of a software system that may be used by the communication system of FIG. 1;

FIG. 4 is a block diagram of a third portion of a software system that may be used by the communication system of FIG. 1;

FIG. 5 is a display of a user interface that may be used by the system of FIG. 1;

FIG. 6 is a display of a user interface for a network that may be used by the system of FIG. 1;

FIG. 7 is a display of an access window for a contact list that may be used by the system of FIG. 1;

FIG. 8 is a display of a series of start-up windows that may be used by the system of FIG. 1;

FIG. 9 is a display of a content selection window that may be used by the system of FIG. 1;

FIG. 10 is a display of a content selection choice window that may be used by the system of FIG. 1;

FIG. 11 is a display of access icons that may be used by the system of FIG. 1;

FIG. 12 is a display of a citation viewer window that may be used by the system of FIG. 1;

FIG. 13 is a display of a conversion window that may be used by the system of FIG. 1;

FIG. 14 is a display of a e-mail marketing tool window that may be used by the system of FIG. 1;

FIG. 15 is a display of a chat access window that may be used by the system of FIG. 1;

FIG. 16 is a display of a chat window that may be used by the system of FIG. 1;

FIG. 17 is a display of a sign in window that may be used by the system of FIG. 1;

FIG. 18 is a display of a contact selection window that may be used by the system of FIG. 1;

FIG. 19 is a display of an access selection window that may be used by the system of FIG. 1;

FIG. 20 is a display of a thumbnail selection window that may be used by the system of FIG. 1;

FIG. 21 is a display of a network information entry window that may be used by the system of FIG. 1;

FIG. 22 is a display of a contact entry window that may be used by the system of FIG. 1;

FIG. 23 is a display of a network permissions entry window that may be used by the system of FIG. 1;

FIG. 24 is a display of a network display window that may be used by the system of FIG. 1;

FIG. 25 is a display of an import contacts entry window that may be used by the system of FIG. 1;

FIG. 26 is a display of a project creation window that may be used by the system of FIG. 1;

FIG. 27 is a display of citation entry window that may be used by the system of FIG. 1;

FIG. 28 is a display of citation presentation window that may be used by the system of FIG. 1;

FIG. 29 is a display of an upload window that may be used by the system of FIG. 1;

FIG. 30 is a display of an upload confirmation window that may be used by the system of FIG. 1;

FIG. 31 is a display of file format display window that may be used by the system of FIG. 1;

FIGS. 32-33 is a display of a succession of sign on window that may be used by the system of FIG. 1;

FIG. 34 is a display of user profile window that may be used by the system of FIG. 1;

FIG. 35 is a display of a network display window that may be used by the system of FIG. 1;

FIG. 36 is a display of a project window that may be used by the system of FIG. 1; and

FIG. 37 is a display of a syndication window that may be used by the system of FIG. 1.

### DETAILED DESCRIPTION OF AN ILLUSTRATED EMBODIMENT

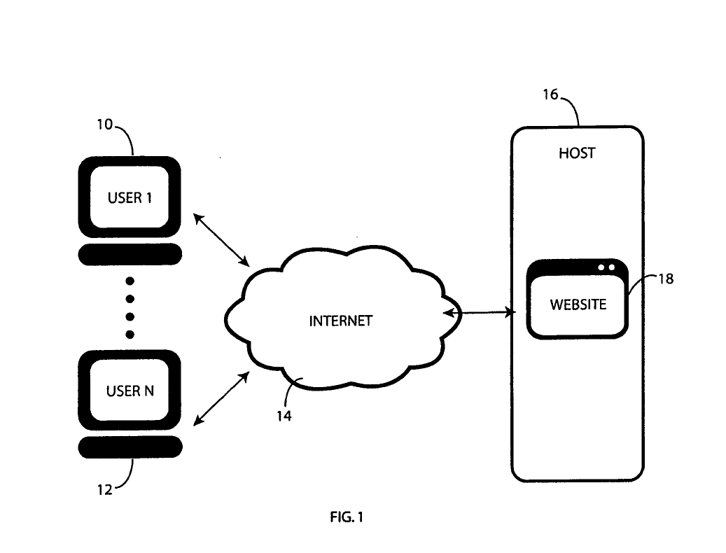

FIG. 1 depicts a communication system shown generally in accordance with an illustrated embodiment of the invention. As shown, any of a number of users 10, 12 may save information within a website system 18 located within a host 16.

As the Internet has become incorporated into how we communicate, professionals in the workforce are constantly citing information that they find online and trying to make use of when communicating with customers and peers. In this past, there were very few ways of bringing together web content, streaming media, well-formed documentation and analysis into a single location that can be easily accessed and distributed . . . until now.

The system of FIG. 1 solves this problem by providing a website platform 18 for keeping this information organized, stored, and delivered. The system of FIG. 1 is a collaboration platform (often hereinafter referred to by the descriptive term “SNiPiTRON”) 18. It is referred to as a platform 18 because it serves as a foundation for many different applications that arise over time. One application of the platform 18 and the primary focus of the discussion below is in the area that can be referred to as “social research”.

Social Research is the concept created by the inventors, to define the process of capturing information from online sources and sharing with peers. This is a process which all of us in the workforce have performed, in various ways. For instance, the typical way a user would do this is by copy-pasting information the user finds online into a Word document, then emailing that document to his/her co-workers. Or worse yet, printing pages from websites and creating physical handouts. This type of research is typically lost and forgotten quickly.

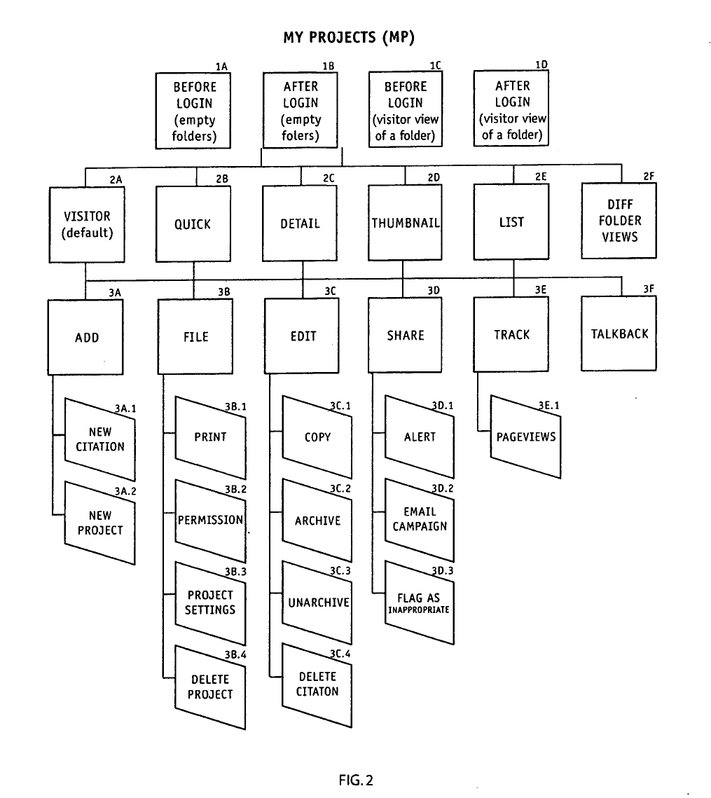

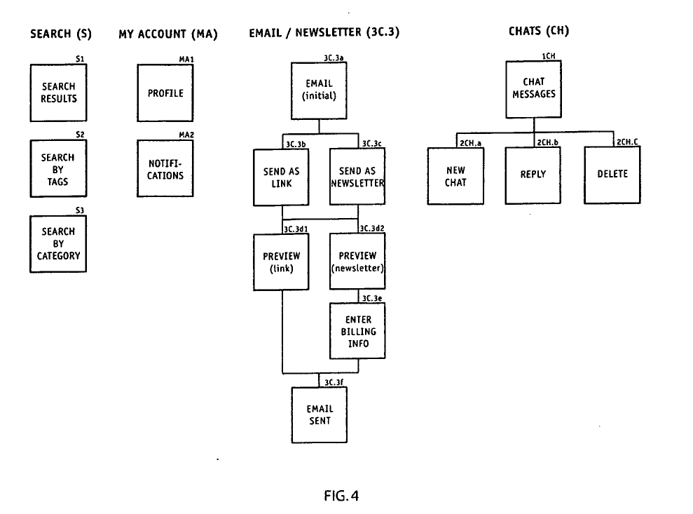

The platform 18 allows the user to capture information from online websites and files from their computer into a single location. FIGS. 2-4 depict a series of software applications operating within the platform 18. The user can use the applications of FIGS. 2-4 to add content that can be stored along with the captured information. This information is stored in secure environment where it can be referenced any time in the future. Information that the user captures is stored as subject matter resources associated with research projects. A research project is made up of “citations”. A citation can be a website, document, audio file, video, photo, or formatted (i.e. “rich”) text. Research projects can then be shared with a group of peers, or a network containing few to hundreds or thousands of individuals

The platform 18 encompasses the basic building blocks of collaboration at it's core. User accounts, user profiles, networks and public/private permissions provide the foundation for many different types of applications that can be rolled out over time.

The platform 18 incorporates software applications to perform a number of functions. Social research is one function. Social research may involve gathering information found online and offline, and storing it in a central location.

The platform may also allow file sharing. File sharing provides a single location where users can access documents or content without the need for special hardware or software.

The platform 18 also allows document conversion. Document conversion provides a context wherein all media and documents are converted to a number of different formats for easy viewing and sharing

The platform also allows photo/video storage. With this capability, a user can create galleries of photos and videos which are stored in multiple downloadable formats

The platform also allows competitive analysis. With this capability, a user can keep historical record of websites and content for competitive analysis or legal review

The user may also engage in PR tracking. Using this capability, a user can maintain a single source for all online references made for a particular product or service

The platform may also be used for document revision control, project management, task and asset management. In the case of document revision control, a user can perform in-place editing of office documents between multiple users. In the case of project management, a user can set goals and track project status within the network. In the case of task management, a user may maintain personal or shared to-do lists. In the case of asset management, a user can keep track of inventory, assets, or other personal information in a secure location.

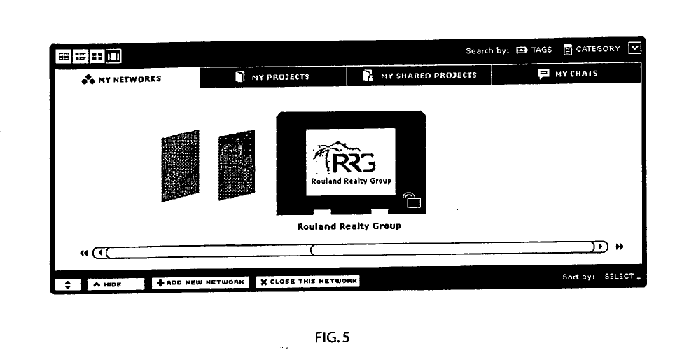

The platform 18 and user interface (FIG. 5) was designed to give users the freedom to use the system in many different contexts. As shown in FIG. 5, there is a navigation area where users can quickly access their projects, networks, and chats. The navigation section may include a MY NETWORKS menu, a MY PROJECTS menu, a MY SHARED PROJECT menu and a MY CHATS menu. The navigation section may also include a search function based upon TAGS or CATEGORY. Within each portion of the navigation section are multiple “views” of the information. When the user clicks on an item from the navigation section, the details of the item open below in a centrally located “details” section.

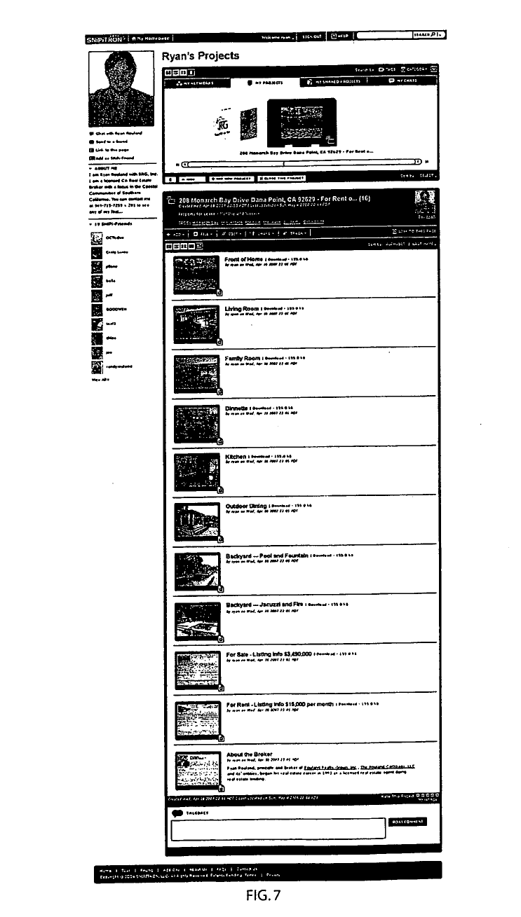

To the left of the navigation and details sections (FIG. 7) is the user profile information. Here, the SNIPITRON user may upload a photo of themselves as well as include Bio or resume information. The user interface of FIG. 5 also includes “tabs” (e.g., MY NETWORKS, MY PROJECTS, MY SHARED PROJECTS, MY CHATS, etc.) so that the user can quickly access those applications from the navigation area.

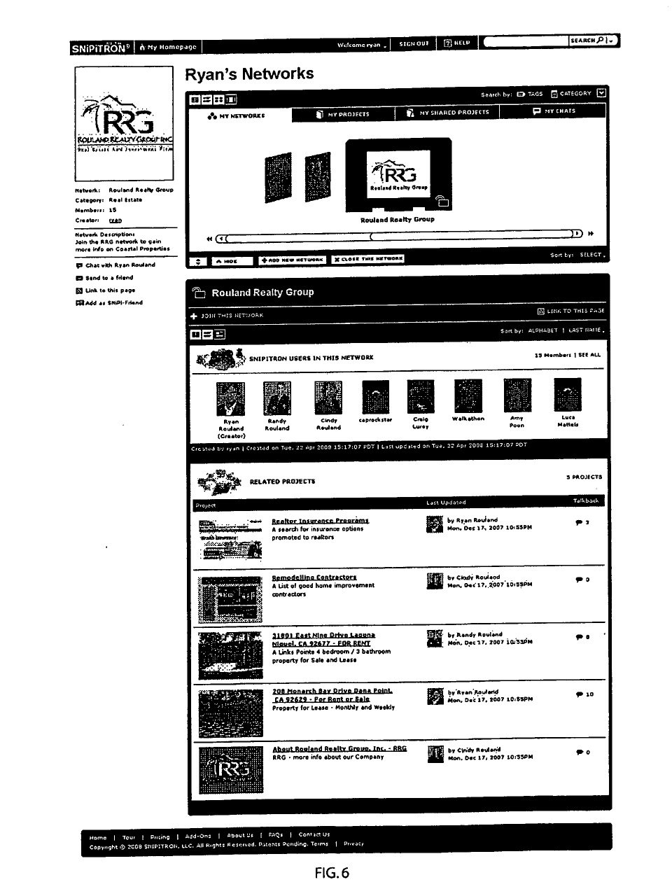

FIG. 6 provides a general view of a network provided by the platform 18. The concept of “social networks” is not new. However the unique aspect of the platform's treatment of networks is that Research Projects can be shared and collaborated within a user's network, as well as distributed through email marketing tools. Additionally, private and public networks can be defined, and those private network members may or may now know about each other, depending upon the preferences of the network owner.

Up until now, the use of Social Networks has been limited to entertainment and friends. The platform 18 extends the use of social networks for business-oriented users. The positive aspects of networks is now applied to increase productivity and communication among peers.

Private and public networks such as that shown in FIG. 6 through the system of FIG. 1 give users the flexibility of making their research projects available to none, few or many. Users can grow the network by inviting your friends or importing contacts from the user's email address book.

Users can assign human contacts to networks and optionally allow the network members to collaborate with each other, enhancing productivity and communication. In addition, projects and the subject matter resources associated with a project may also be assigned to a network. In this regard, a user may have any number of networks and projects. Not all networks have the same human contacts or projects.

A user's projects are easily accessed on the platform 18 as shown in FIG. 7. Getting organized is accomplished by keeping all of a user's project materials in one place—websites, files, screenshots and documentation. A user can specify a project to be public or private. When a user makes his/her research public, it allows the world to benefit from the user's findings. If the user makes his/her project private other users can still share it with others by using the Private Group feature.

The platform 18 supports a wide range of file types including photos, videos, audio, and various document formats. Supported formats include WORD, EXCEL, POWERPOINT, IMAGE, PDF, WEBSITE, AUDIO, VIDEO, ZIP, TEXT, EXE or other.

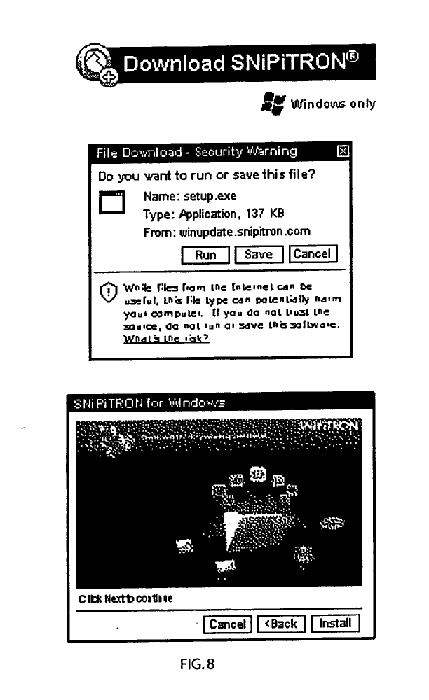

A user can quickly integrate a user client downloaded from the platform 18 into their existing website and online presence to keep the user's content fresh and visible to customers and partners. In this regard, FIG. 8 depicts a hyperlink (top) and two screens (middle and bottom) that may be used to incorporate the functionality of the website 18. As shown, the user may activate the download of the client by activating the link labeled “Download SNIPITRON.” Upon activating the link, the user may select the RUN button on the middle screen of FIG. 8. Finally, the user may finish installation of the user client by activating the Install softkey on the installation wizard shown in the lower screen of FIG. 8.

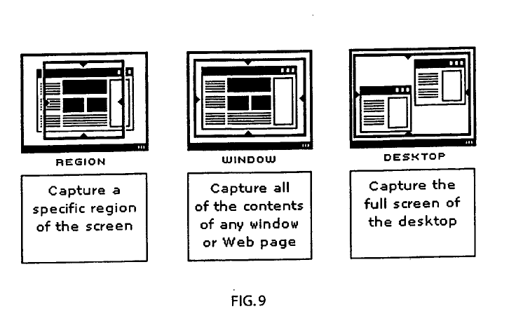

The platform 18 allows customization of captured content. FIG. 9 shows three icons that provide possible ways of identifying content. For example, the user may designate a region of a webpage and activate a REGION softkey on the left side of FIG. 9 to capture only a portion of a webpage. Alternatively, the user may designate an entire webpage and activate a WINDOW softkey as shown in the middle of FIG. 9 to capture a designated window or webpage. Alternatively, the user may activate a DESKTOP softkey on the right side of FIG. 9 to capture the entire desktop.

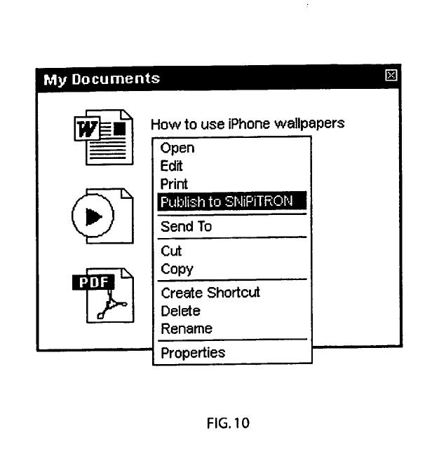

Once a source of information has been designated, a user can select a project file from the menu of project files (e.g., such as that shown in the lower portion of FIG. 6) as a destination for the information. Alternatively, (as shown in FIG. 10) the user can open an existing project file from a user's desktop or simply publish the selected content to the platform 18.

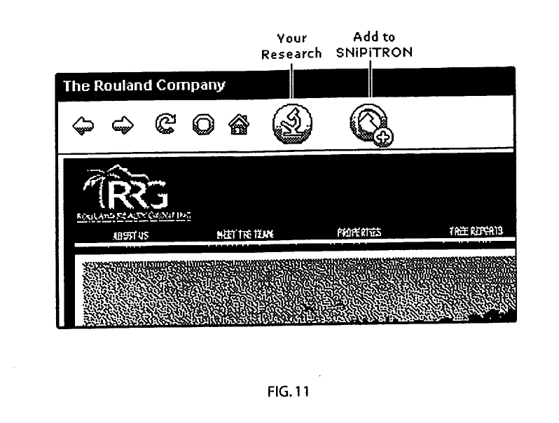

Saving information, in this case, can be initiated through a pair of hyperlinks associated with the platform 18 that are added to an existing webpage browser. As shown in FIG. 11, the user can select a “Your Research” softkey to add to an existing project file or select an “Add to Snipitron” softkey to browse the platform 18.

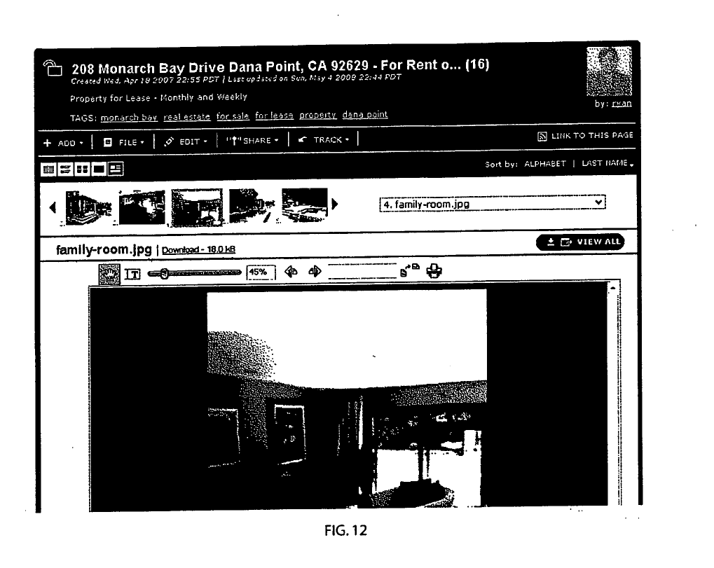

FIG. 12 shows a citation viewer feature. With the citation view, a user can read any file type online without the need to download the file or install software.

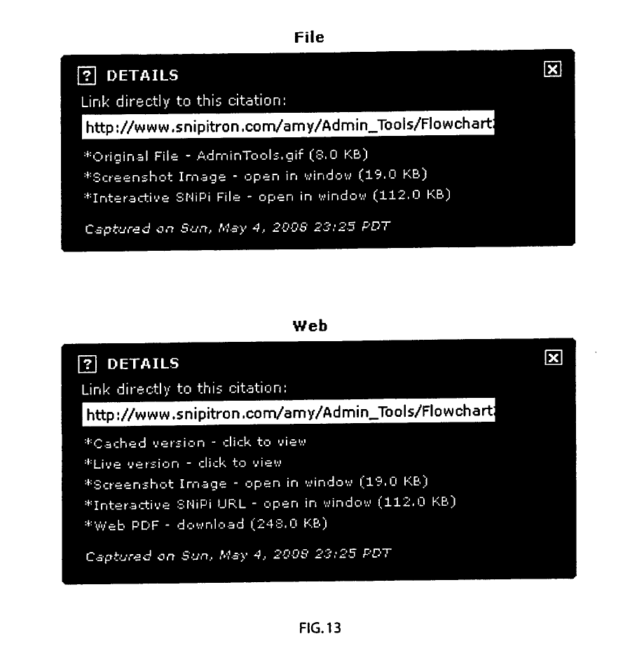

FIG. 13 depicts a pair of format conversion screens that may be depicted to a user upon selection on content. The upper screen of FIG. 13 shows a set of options for selection of a file format. The lower screen of FIG. 13 shows a set of options for a website. The platform 18 converts files and website to PDF and FLASH format that are available for download. The platform 18 also preserves the original file and the cached version of the website—the user doesn't lose any project files or captured web content.

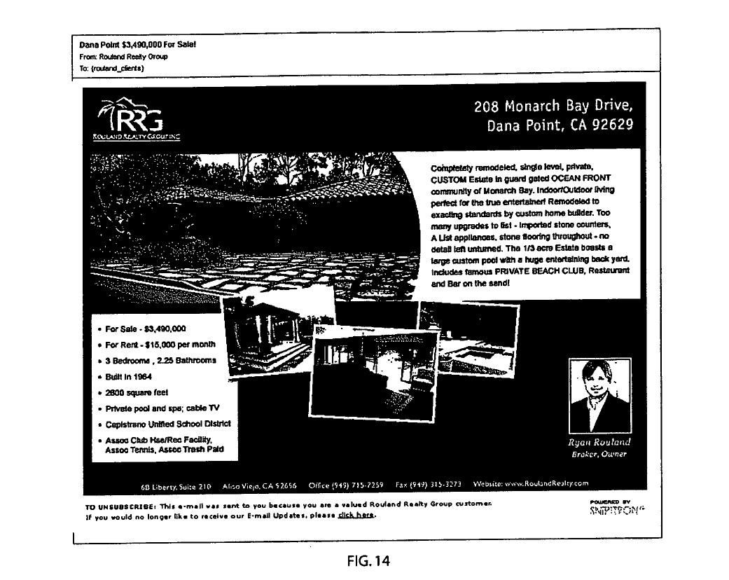

FIG. 14 shows an e-mail marketing tool. Using the e-mail marketing tool of FIG. 14, users are able to turn their research projects into a format which can be sent via email to a few or few thousand people, through SNiPiTRON's email marketing campaign tools. The e-mail marketing tool includes a message scheduling features for scheduling e-mails, an open and click-through tracking feature that tracks and verifies delivery of e-mails and a subscription management feature that allows a user to manage the presentation of e-mails.

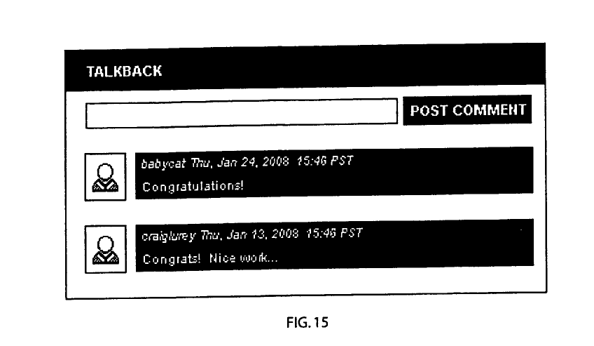

FIG. 15 depicts a talkback feature that allows a user to maximize the user's communication with his/her contacts or other members through SNiPiTRON. In the talkback feature depicted in FIG. 15, a user is able to select a project and a enter text comments into an interactive window. The user may then activate a POST COMMENT softkey adjacent the window to post the message to other members of a group.

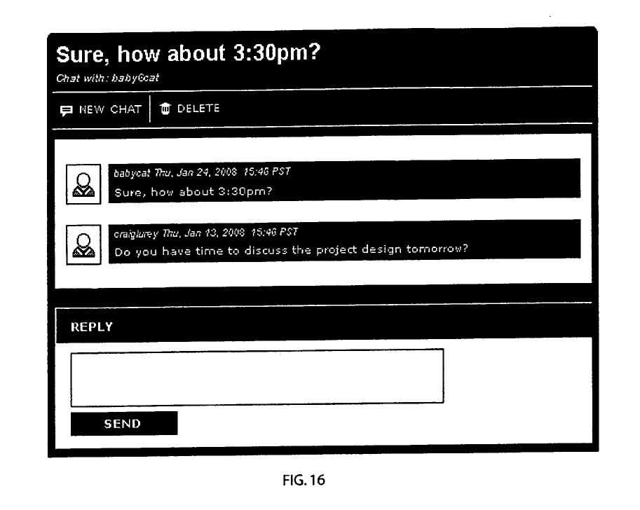

FIG. 16 a tool whereby the user may engage in chat directly with other users. In this case, a user may select the other user from a list and enter text through an interactive box at a bottom of the chat tool of FIG. 16 and activate a REPLY softkey.

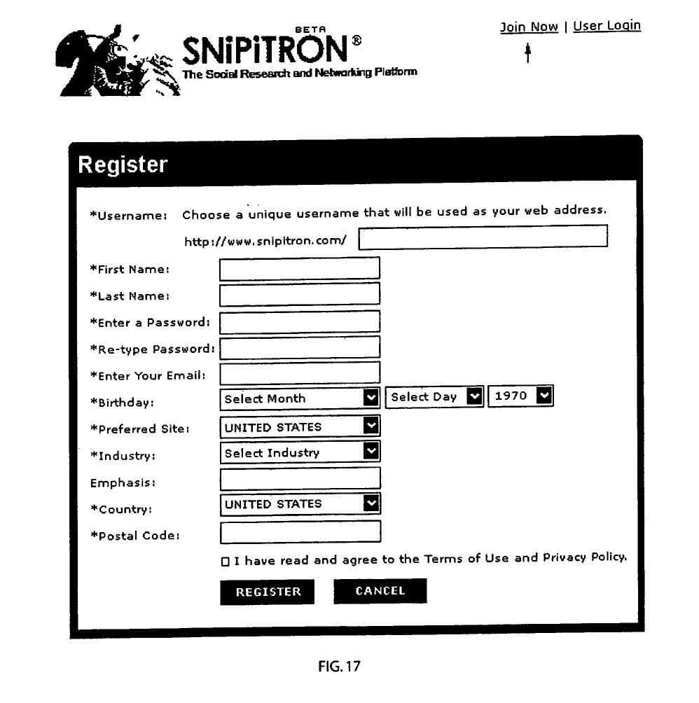

A detailed example will now be offered of the use of the platform 18. For example, to open an account on the platform 18, a user may activate a Join Now softkey located in the upper right corner of the initial webpage shown in FIG. 17. In response, the account open webpage at the bottom of FIG. 17 is presented to the user.

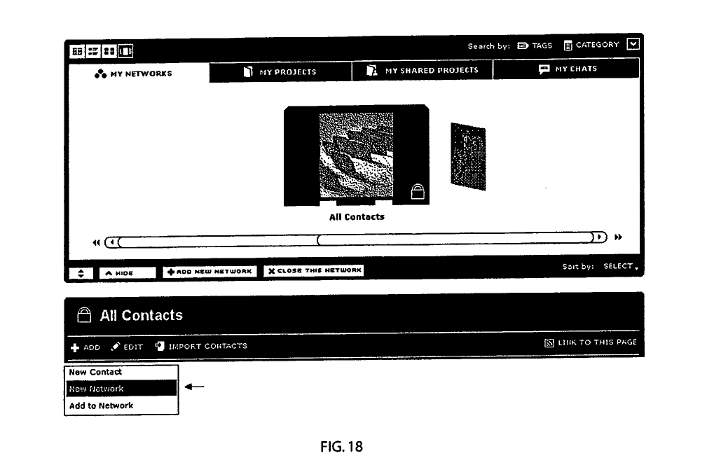

In the account open webpage, the user may enter a username and password. The username is later used to access the user's home page. Once the user has created an account on the platform 18, the user may be presented with the webpage of FIG. 18 for the creation of networks. As shown, there are two pre-built networks: 1) “All Contacts” and 2) “SNiPiFriends.”

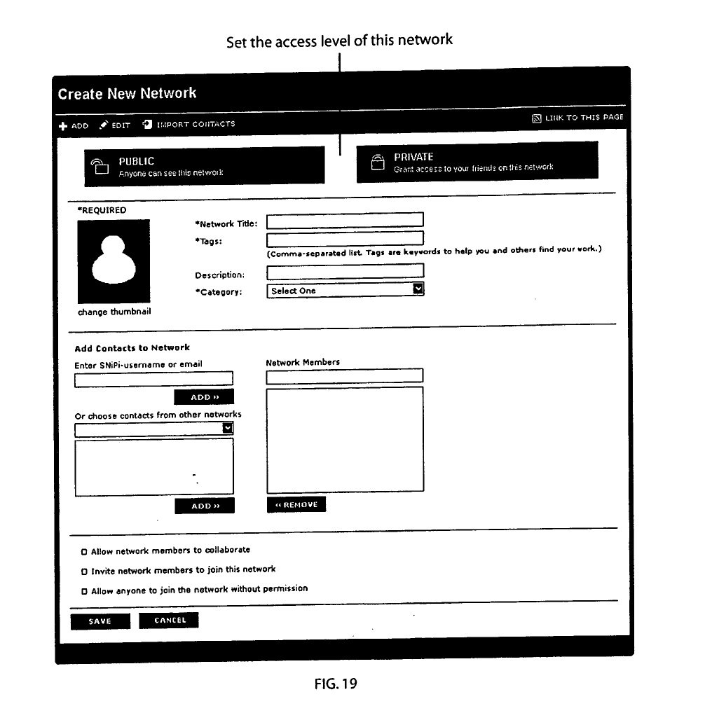

Once a user has created a new network (via activation of the New Network softkey by the cursor shown in the lower left of FIG. 18), the user may be presented with the webpage of FIG. 19. Networks can be public or private and can be selected by a PUBLIC or PRIVATE softkey as shown in FIG. 19. Public networks always allow the members to collaborate with each other.

Private networks may or may not allow collaboration between members, based on user settings. For instance, if a user creates a network of customer accounts, the user probably wouldn't want them collaborating with each other. In this case the user would create a personal and private network, only available for the user's own use.

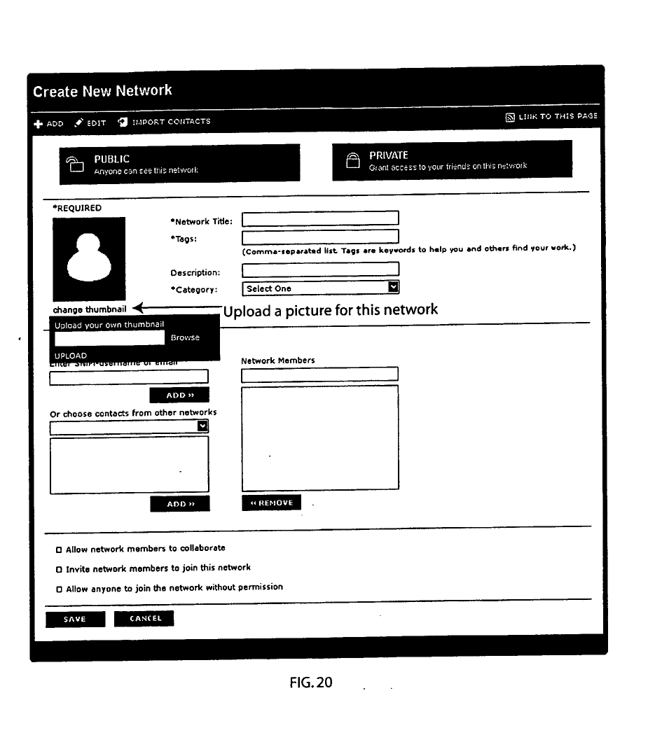

FIG. 20 depicts a webpage where a thumbnail icon may be associated with a network via a CHANGE THUMBNAIL softkey. The thumbnail icon of each new file may be presented by default as a question mark. The CHANGE THUMBNAIL softkey may be used when creating a network to customize the photo/thumbnail representing the network to a user's preferences.

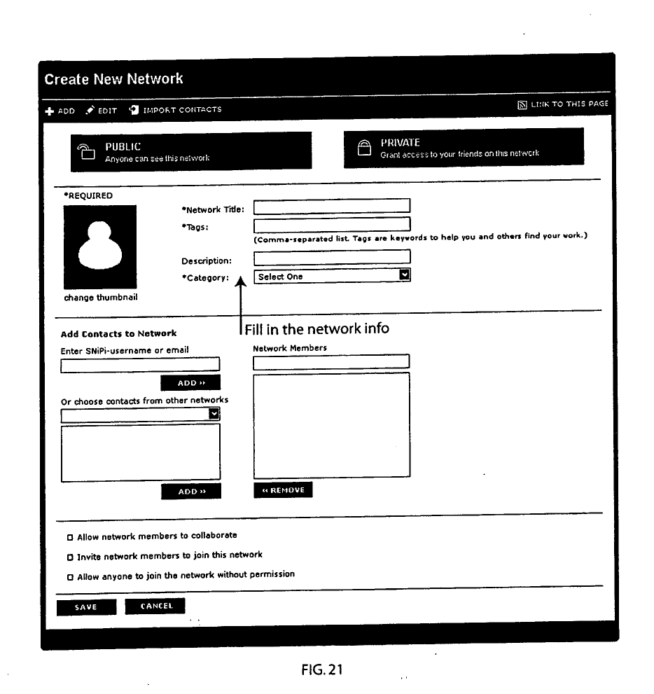

FIG. 21 depicts a set of interactive windows for entry of descriptive information regarding the network. A network title may be entered through a first window for presentation beside the photo/thumbnail. A tag window is provided for use in classifying the network for easy lookup (e.g., searching) at a later time. A category drop-down menu is provided to classify the network at a high level (e.g., business, education, science, etc.). Invitations to the network are automatically sent out based on the type of network and the permissions set for the network.

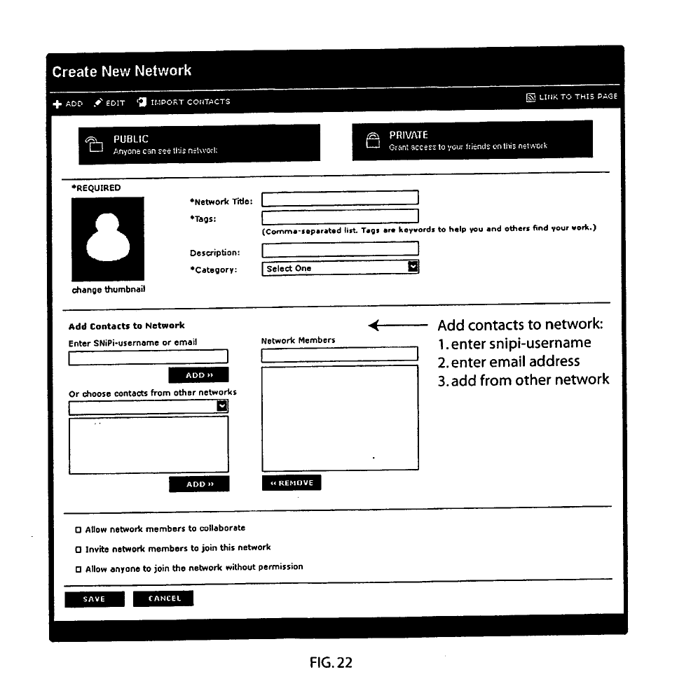

FIG. 22 shows the addition of human contacts to the network. As shown, an address line (adjacent the cursor) may be provided for entry of contacts (e.g., e-mail addresses of associates, friends, etc.). When adding contact, a user can select and incorporate contacts from other networks (e.g., OUTLOOK) or type in the user name and address directly.

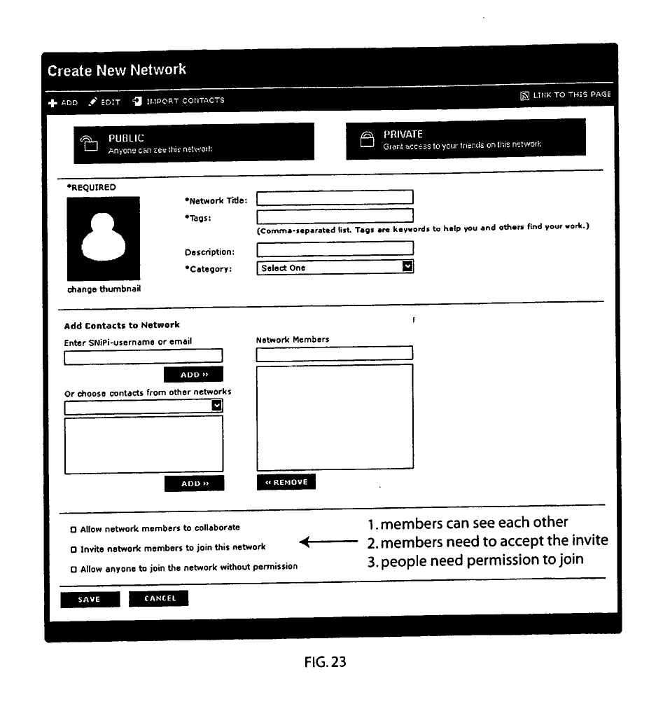

FIG. 23 shows a network permissions selection line (adjacent the cursor). Network permissions determine whether users can see each other, or if e-mail notifications should be sent out.

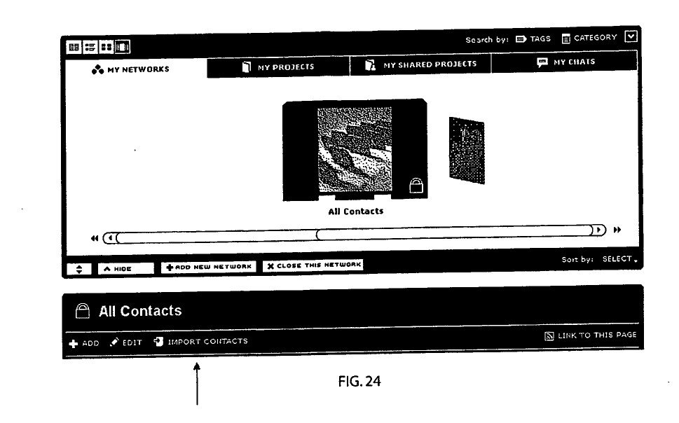

FIG. 24 (top web page) shows a network display area after creating the new network. After each network is created, a new network file is created. The new network also shows up in the network display (navigation) area as an icon (e.g., a thumbnail) that, in this case of FIG. 24, is identified by the cursor.

When a user selects a network (e.g., the Best Friends network) in the upper web page of FIG. 24, a network display page (lower web page of FIG. 24) opens. In order to add contacts, a user may place his/cursor over an IMPORT CONTACTS softkey (as shown in FIG. 24) and activates the cursor to open an import contacts web page. The user may importing contacts via EXCEL, OUTLOOK or other multiple formats to allow for the quick creation of a user's network.

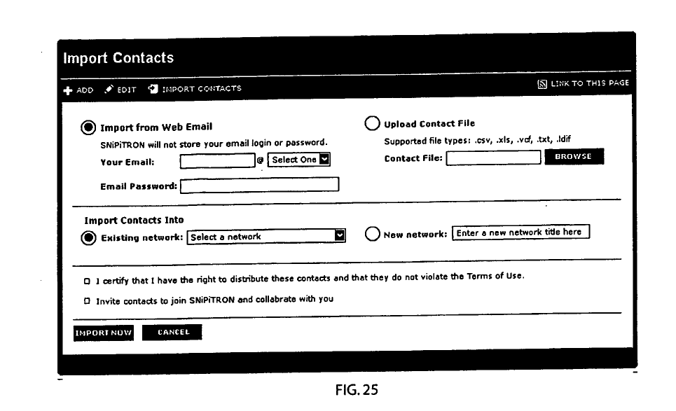

FIG. 25 shows an IMPORT CONTACTS web page. A lower portion (labeled IMPORT CONTACTS INTO) provides a menu of existing networks to allow the user to select an existing network. Alternatively, the user may enter a title into a window labeled “ENTER A NEW NETWORK TITLE HERE” and activate an associated softkey to create a new network.

The top section labeled “SELECT CONTACT FILE” allows the user to select e-mail addresses of contacts and also to add contact files to the network file. In general, the webpage of FIG. 25 allows a user to determine which networks are applied or a user can create a new network on the fly.

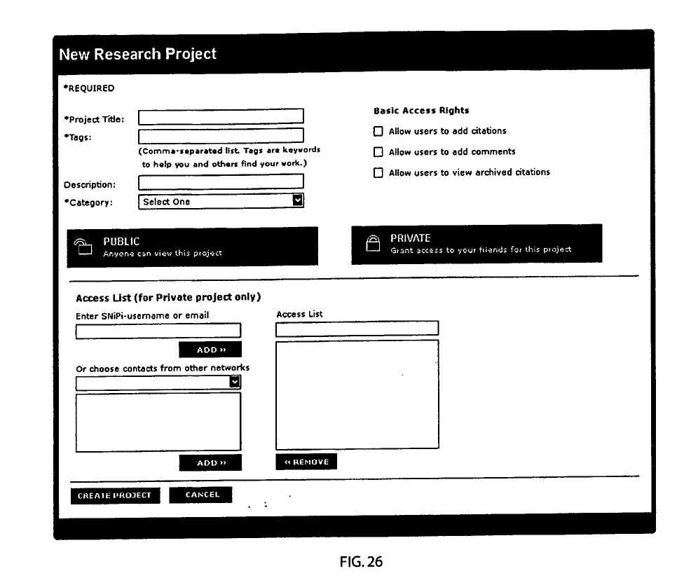

An explanation will now be provided about how the platform 18 may be used to incorporate projects in the context of an existing web browser. For example, FIG. 26 depicts a Create New Project webpage that may be opened by activation of the Add to SNiPiTRON softkey of FIG. 11. The webpage of FIG. 26 may be provided to a user upon setting up a new account as shown by the text adjacent the cursor shown near the top of the new project webpage.

In general, a project (or “Research Project”) is made up of citations which can be any file format (e.g., web page, office document, audio, video, etc.). There are a number of ways to create a project. The example of FIG. 26 is accomplished using the web browser toolbar.

When adding a website or file, if there are no projects created, the user will be asked to create the user's first project and project file. The user is prompted for descriptive information through a number of windows. Through a first interactive window labeled “Project Title” the user may enter a title to identify the project. Through the second window entitled “Tags”, the user may enter terms that may be used for searching. Through a third window entitled “Description”, the user may enter descriptive information. The user may also be provided with a pull-down menu entitled “Category” where the user may select a general category of the project.

Projects can be Public or Private as designated by activation of one of the PUBLIC or PRIVATE softkeys by the cursor shown adjacent the PRIVATE softkey in FIG. 26. Private projects can be just for the user's own use, or assigned to a few or few thousand members within a network. The user can also decide whether or not other users have the ability to add citations (information), add comments (i.e. Talkback) or view archived citations.

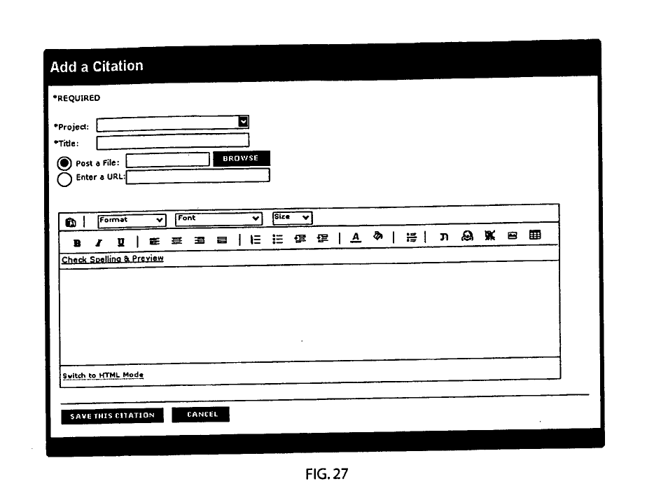

Once a new project has been created, the user may be presented with an Add Citation window as shown in FIG. 27. The project identifier and title may be carried over from the prior page. Alternatively, the user may select to add a citation to a new project by activating the NEW softkey.

A pair of interactive boxes adjacent the identifier “Type” are shown in FIG. 27. The pair of boxes may be used to first identify the source and path to the source. A citation can be to a website, file or rich text. The user may then activate a SAVE CITATION softkey.

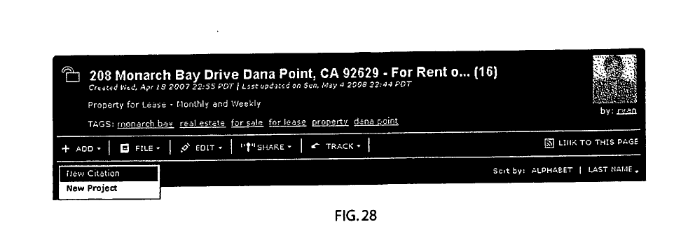

Once the new citation is saved to the designated project, the user may be presented with the window shown in FIG. 28. In the upper left corner may be a number of softkeys (e.g., FILE, ADD WEBSITE, etc.). The user may add other citations by activating the FILE softkey to upload other citations or the ADD WEBSITE to select website material as citations. In the example of FIG. 28, the user activates the UPLOAD softkey to add a new citation to the identified project.

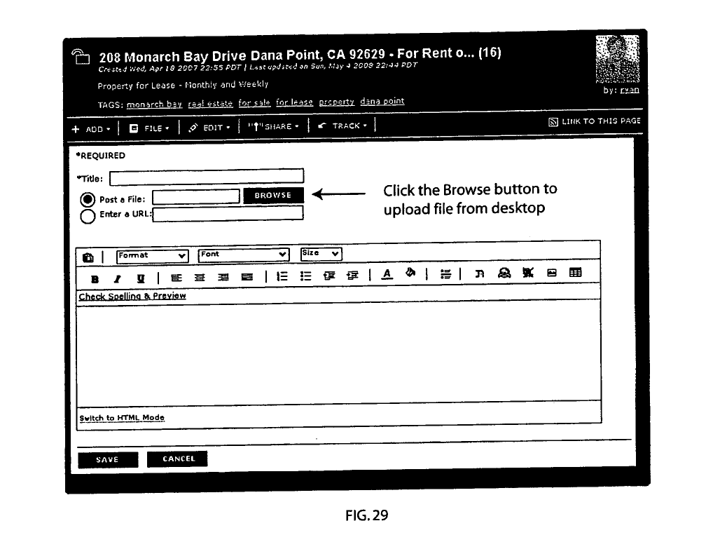

FIG. 29 depicts an example of a citation that may be uploaded. In this case, the user may locate an audio file on the user's computer using a cursor to activate a BROWSE softkey. Activation of the BROWSE softkey by the cursor allows a user to browse his/her own or other connected systems for a source of the citation. The source content and path appear in the windows to the left of the cursor. Once a source is identified, the user, again, may activate the SAVE softkey.

In all cases, once a file is identified, the SAVE softkey is activated to add the one or more files to the project and/or network file. Files are stored on SNiPiTRON's servers, and will automatically be converted into a realtime FLASH viewable format, in addition to PDF format, if applicable

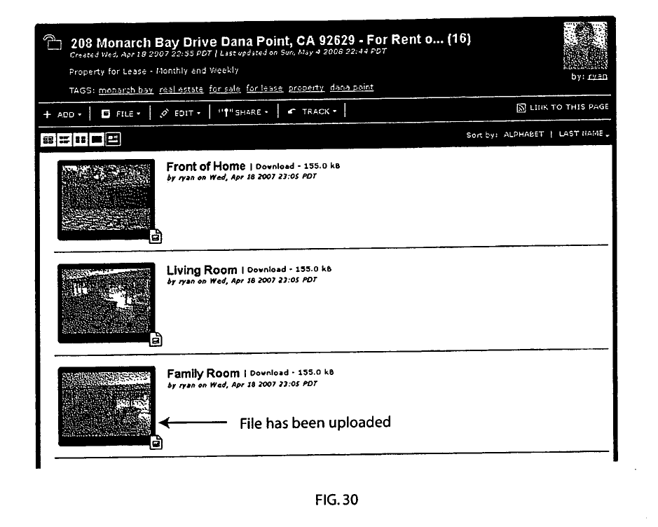

FIG. 30 shows a window that may be displayed to the user upon activation of the SAVE softkeys of FIGS. 27 and 29. In this case, the project name appears in the header along with a list of citations added as a menu. As depicted by the cursor in FIG. 30, audio files are automatically converted to a flash format in the platform 18 along with an embedded player.

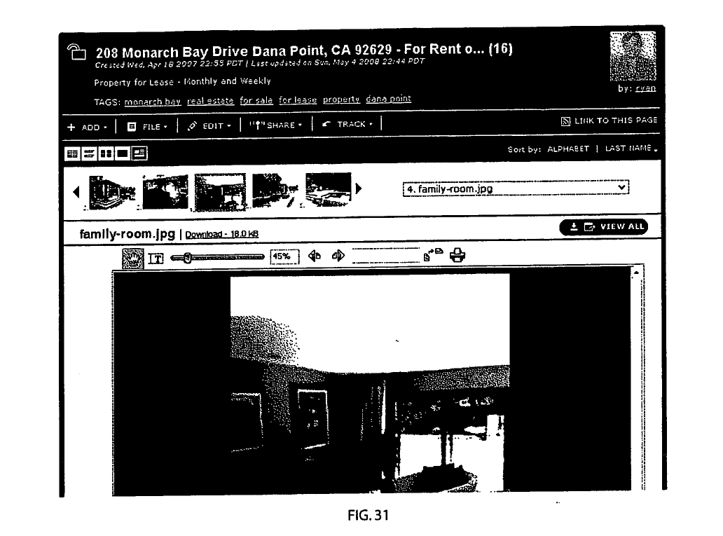

Associated with the list of citations is a citation viewer. In this case, a user may simply place the cursor over a citation as shown in FIG. 31 to activate the citation viewer. The citation viewer performs real-time conversion of standard file formats into viewable flash. The citation viewer also allows the user to view and download the citation in a multitude of formats. Users can also “share” the citation with others via hyperlink or email.

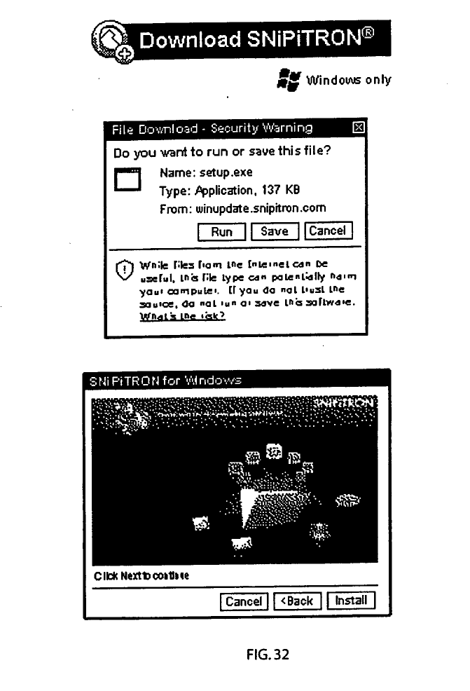

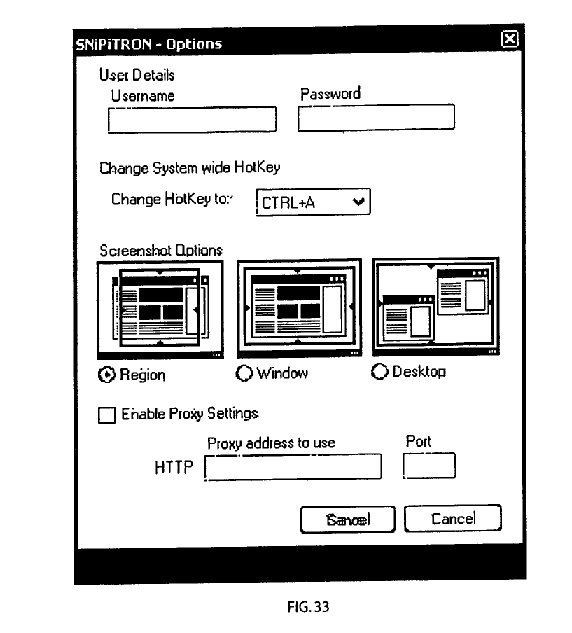

FIGS. 32-33 is similar to FIG. 8 and shows additional detail about the installation of the SNiPiTRON user client. In this case, The SNiPiTRON downloadable application for Windows computers is important to the use of the service. The application allows the user to capture web pages, screenshots and files from the user's computer with a single click or keyboard shortcut. In this case, the user may click the “Download” button and follow the installation steps shown in FIG. 32.

After installation, the user is asked to enter his/her SNIPITRON username and password. The user can also choose his/her preferences for the type of screenshot, and also which “hot key” will activate the application. Within the user's desktop, the user's browser (e.g., Firefox, Internet Explorer, etc.) will be automatically enhanced with the SNIPITRON feature buttons.

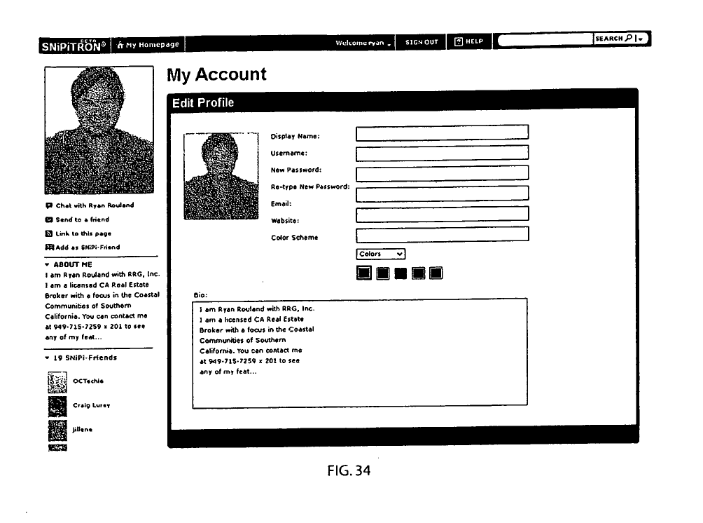

Included within the platform 18 are provisions for each user to create a personal profile as shown in FIG. 34. User profiles are important for personalizing the look and feel of the user's SNIPITRON application. Each user can customize the color scheme, photo and personal information. When uploading a photo, embedded crop and rotation tools are provided to simplify the creation of your imagery.

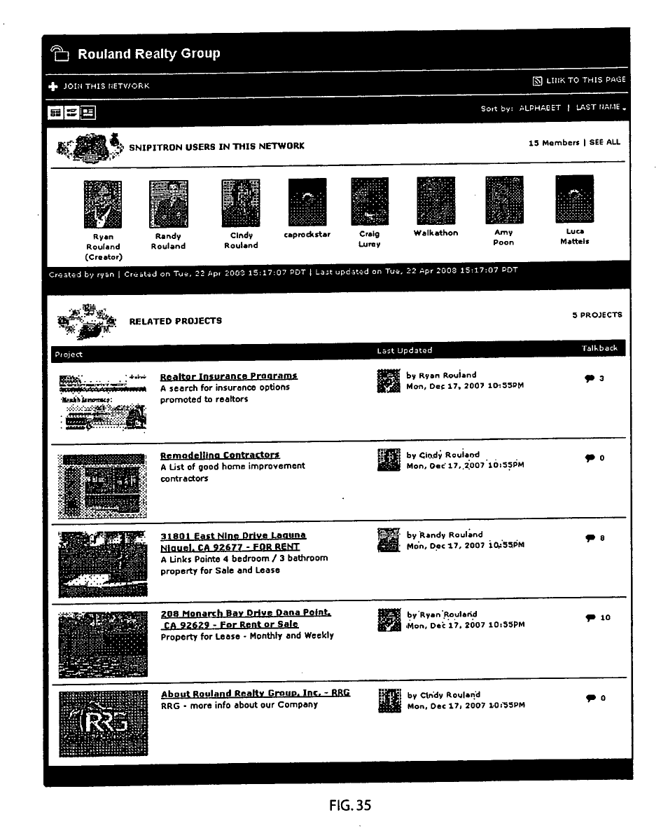

FIG. 35 shows an example of a fully populated network. Shown along a top row may be thumbnails of human contacts that have been added to the network. The profile of each contact may be viewed by clicking on the thumbnail.

Shown below the contacts is a list of related projects that may be shared among the group of contacts shown in the first row. Each project in the list may include a thumbnail of the project as well as a title and description. A further reduced thumbnail of the contact providing the last update is provided adjacent the thumbnail of the project under the Last Updated heading. Under a Talkback heading is shown an icon for each project where a user can activate the icon to access the window of FIGS. 15 and 16 in order to retrieve the latest chat or e-mail messages for each project.

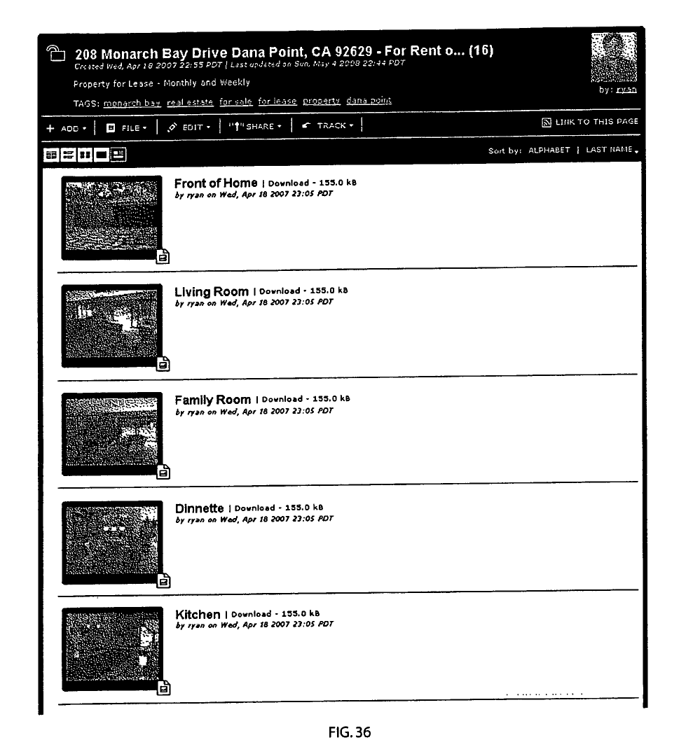

FIG. 36 shows a content view of one of the projects shown in FIG. 34. A fully-loaded Research Project such as that shown in FIG. 34. Photos, rich text and website content are integrated into a visually pleasing format. This research project can be shared, emailed and published in many ways through the SNIPITRON tools.

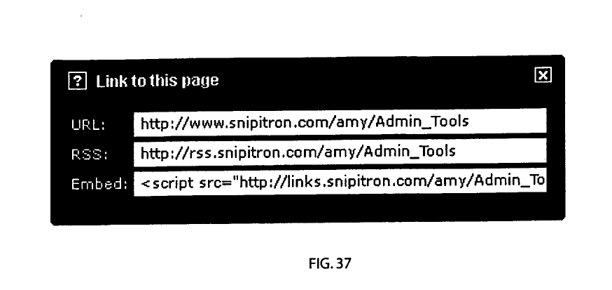

FIG. 37 shows a window that may be activated by the LINK TO THIS PAGE softkey shown in the upper right corner of FIG. 35. SNiPiTRON projects are easily syndicated to human or other contacts through the internet via the use of RSS and embedded links. The linking of a page of subject matter to one or more human contacts establishes a network.

RSS (Really Simple Syndication) is a format for syndication using XML syntax. It is used across the Internet to feed blogs and news sources everywhere. SNiPiTRON has been implemented to use RSS in conjunction with Networks, Projects and Citations within the system. On every page which can be syndicated, you will see a feature called “LINK TO THIS PAGE”: Here, the user can select a URL, RSS feed or embedded page. Website developers can use these links to syndicate SNIPITRON content to other sources in a standardized format.

FIGS. 2-4 depict a set of software programs or modules that provide the functionality of the invention. For example, modules 2A-F provide the basic functionality of the home webpage of FIG. 5. The “All Contacts” icon shown in FIG. 5 may be used to activate the file control module 3A of FIG. 2. The edit icon (shown as a stylized squirrel in FIG. 5) may be used to activate the edit module 3B of FIG. 2. The share icon (shown as the outline of a person in FIG. 5) may be used to activate the share module 3C of FIG. 2.

The control module 3A and 3A-1 may be used in conjunction with the windows of FIGS. 25-31 to upload and save files. Included within the control module 3A-1 may be one or more information capture processors that receive citations via the windows of FIG. 27 or 29, retrieve the designated information and save the retrieved information in respective project and/or network files. A format subroutine of the control module 3A-1 may retrieve and identify a currently operating application identifier from a stack of the multitasking operating system to determine a format of the citation (e.g., WORD, HTML, pdf, etc.). Also included may be one or more descriptive information processors that receive descriptive information through the respective windows and that associate the information with the respective project files. Other program modules 3A-2 to 3A-4 may be used to provide print functions, to change project settings and to delete projects.

The editing module 3B may also include other associated modules, such as a copy module 3B-1, an archiving module 3B-2, an unarchiving module 3B-3 and a deletion module 3B-4. The editing modules 3B may also include modules for editing the different views such as a visitor module 3B-5A that may display visitor examples, a detail module 3B-5C for editing file details, a quick view module 3B-5B for providing an overall view of a project, a thumbnail module 3B-5D for editing thumbnail views and a list module 3B-5E for editing files.

The share module 3C may includes a permissions module 3C-1 for editing the content and identity of access to networks and projects. The share module 3C may also include an e-mail module 3C-3 for handling e-mails, a flagging module 3C-4 for flagging based upon predetermined criteria and an alerts module 3C-2 to alert a user to events such as the receipt of e-mails, etc. The share module 3C may also include an “add as friend” module 3C-5 module to allow visitors to view content.

Other functionality provided by the platform 18 may include a tracking module 3D to track changes to the networks and projects. A talkback module 3E is provided for chat sessions. A rating module 3F may be provided that allows visitors to the web site to rate the web site.

Various interfaces 1A-D may be provided to control access to the website based upon status. For example, a first module 1A may limit access and process requests from a user using a first process before log in, while a second module 1B may process requests differently after log in. Similarly, visitors may use first and second modules 1C-D based upon status.

A number of other program modules G1, G2, G6 may operate in conjunction with the other modules discussed above to handle graphics. Special purpose modules, such as a login/register module G3 may prompt a visitor to log in. Another module G4 may prompt a user to enter an e-mail address in order to tell a friend. Still another module G5 may generate error or other messages.

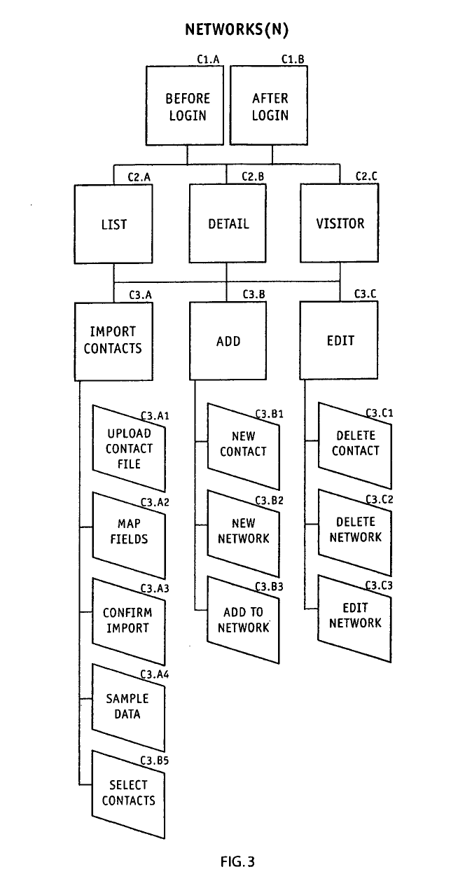

Another set of modules C2-A to C2-D may handle the processing of network requests such as those discussed in conjunction with FIG. 6. For example, an Import Contacts module C3-A may be used in conjunction with an IMPORT CONTACTS softkey shown in FIG. 3 to identify human contacts to be added to an authorized user file for each network. Other program modules C3-A1 to C3-A4 and C3-B5 may perform the respective tasks of uploading contact files, mapping fields, confirming imports, sampling data and providing an interface for selecting contacts.

An add module C3-B may be used in conjunction with the window of FIG. 18 to add contacts. In this regard, the New Contact module C3-B1, New Group module C3-B2, Add to Group module C3-B3 and Add to Project module C3-B4 may be used in conjunction with the corresponding menu items shown in FIG. 18 to add the appropriate combination of contacts.

One or more security processors may receive messages from contacts and may verify the authorization of the contacts to access the networks and project files.

Similarly, an Edit module C3-C may be used in conjunction with the EDIT softkey shown in FIG. 18 to edit the contacts. As above, a Delete Contact module C3-C1 may be used to delete individual contacts, a Delete Group module C3-C2 for groups and a Edit Contact module C3-C3 may be used to edit details of contacts.

A first module C1-A may be used to vary the interface where the user is not logged into the system. A second module C1-B may be used to provide another interface where the user is logged in.

A search function module C1-C is provided to search by network. In this case, the searches may be based upon keywords.

An embedded browser W1 may be included within the platform 18 to search the web. An associated module W2 may be provided to add URLs to projects based upon the search results.

A Search Results module S1 may be provided for searches for contacts. Another associated Search by Tags module S2 may be provided to search networks and projects based upon associated tags entered by a user. A third Search by Category module S3 may be provided for searching by category information entered by a user.

A Chat Messages module CH1-A and associated Setting module CH1-B may be provided as a private communication interface for processing chat messages among members of each defined group of contacts. A first Read module CH2-A may provide a chatbox for handling chat messages. A Delete module CH2-B may be used to delete messages while a New Chat module CH2-C may initiate new chat sessions.

Other modules may take care of bookkeeping. For example, a Profile module MA-1 may contain information about each user. A Settings module MA-2 may include each user's settings, while another Modifications module MA-3 may allow modifications of accounts. Still another Upgrade Account module MA-4 may allow a user to upgrade his/her account.

A series of Browser Upload modules B1-4 may be used in conjunction with the windows of FIGS. 8, 32 and 33 to install the platform 18. A first Sign In module B1 may collect information from a user and verify the identify of the user. A second Create Project module B3 may allow a user to create projects. An Add Webpage module B3 may allows user to expand the content of projects based upon the scope and breadth of the content. A Follow-Up Screen module B4 may be used to confirm changes (e.g., the addition of citations).

A Projects/Contacts/Reports module CF-1 may generate data from the operation of the other modules. A How It Works module CF-2 may provide a tutorial on the use of the platform 18.

A specific embodiment of method and apparatus for creating and networking social content has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of providing searchable data comprising:
detecting a content capture request from a user;
analyzing a portion of a screen being viewed by the user to capture a content and format of any information elements displayed on the portion;
prompting the user for descriptive information about the viewed content; and
saving the captured content and format and descriptive information as a subject matter resource within a subject matter resource file located at a predetermined website or physical location on the user's computer.

2. The method of providing searchable data as in claim 1 wherein the captured content and format further comprises a file content being viewed on the screen by the user.

3. The method of providing searchable data as in claim 1 wherein the captured content and format further comprises a screenshot of an active window being viewed by the user.

4. The method of providing searchable data as in claim 1 wherein the captured content and format further comprises a thumbnail screenshot of an active window being viewed by the user.

5. The method of providing searchable data as in claim 1 wherein the captured content and format further comprises an html page source and accompanying content including graphics, scripts and other content to reconstruct the page of any web site being viewed by the user.

6. The method of providing searchable data as in claim 1 wherein saving the captured content further comprises prompting the user to save the captured content and format and descriptive information in an existing subject matter content resource file or a new subject matter content resource file.

7. The method of providing searchable data as in claim 1 further comprising searching the descriptive information using keywords.

8. The method of providing searchable data as in claim 1 further comprising defining a group of human contacts to be given access to the subject matter resource.

9. The method of providing searchable data as in claim 8 further comprising providing a private communication interface for exchanging message among the defined group regarding the subject matter resource.

10. The method of providing searchable data as in claim 9 further comprising e-mailing notifications of the subject matter resource to the defined group.

11. An apparatus for providing searchable data comprising:
means for detecting a content capture request from a user;
means for analyzing a portion of a screen being viewed by the user to capture a content and format of any information elements displayed on the portion;
means for prompting the user for descriptive information about the viewed content; and
means for saving the captured content and format and descriptive information as a subject matter resource within a subject matter resource file located at a predetermined website or physical location on the user's computer.

12. The apparatus for providing searchable data as in claim 1 wherein the captured content and format further comprises a file content being viewed on the screen by the user.

13. The apparatus for providing searchable data as in claim 11 wherein the captured content and format further comprises a screenshot of an active window being viewed by the user.

14. The apparatus for providing searchable data as in claim 11 wherein the captured content and format further comprises a thumbnail screenshot of an active window being viewed by the user.

15. The apparatus for providing searchable data as in claim 11 wherein the captured content and format further comprises an html page source and accompanying content including graphics, scripts and other content to reconstruct the page of any web site being viewed by the user.

16. The apparatus for providing searchable data as in claim 11 wherein the means for saving the captured content further comprises means for prompting the user to save the captured content and format and descriptive information in an existing subject matter content resource file or a new subject matter content resource file.

17. The apparatus for providing searchable data as in claim 11 further comprising means for searching the descriptive information using keywords.

18. The apparatus for providing searchable data as in claim 11 further comprising means for defining a group of human contacts to be given access to the subject matter resource within a network.

19. The apparatus for providing searchable data as in claim 18 further comprising means for providing a private communication interface for exchanging messages among the defined group regarding the subject matter resource.

20. The apparatus for providing searchable data as in claim 19 further comprising e-mailing notifications of the subject matter resource to the defined group.

21. An apparatus for providing searchable data comprising:
a citation window for defining a portion of a screen being viewed by the user to capture a content and format of any information elements displayed on the portion;
a set of interactive boxes for prompting the user for descriptive information about the viewed content; and
a network for saving the captured content and format and descriptive information as a subject matter resource within a subject matter resource file located at a predetermined website or physical location on the user's computer.

22. The apparatus for providing searchable data as in claim 21 wherein the captured content and format further comprises a file content being viewed on the screen by the user.

23. The apparatus for providing searchable data as in claim 21 wherein the captured content and format further comprises a screenshot of an active window being viewed by the user.

24. The apparatus for providing searchable data as in claim 21 wherein the captured content and format further comprises a thumbnail screenshot of an active window being viewed by the user.

25. The apparatus for providing searchable data as in claim 21 wherein the captured content and format further comprises an html page source and accompanying content including graphics, scripts and other content to reconstruct the page of any web site being viewed by the user.

26. The apparatus for providing searchable data as in claim 21 wherein the means for saving the captured content further comprises means for prompting the user to save the captured content and format and descriptive information in an existing subject matter content resource file or a new subject matter content resource file.

27. The apparatus for providing searchable data as in claim 21 further comprising a search feature that searches the descriptive information using keywords.

28. The apparatus for providing searchable data as in claim 21 further comprising a group of human contacts defined to be given access to the subject matter resource within a network.

29. The apparatus for providing searchable data as in claim 28 further comprising a private communication interface that exchanges messages among the defined group regarding the subject matter resource.

30. The apparatus for providing searchable data as in claim 29 further comprising notifications of the subject matter resource e-mailed to the defined group.
